(19) United States
(12) Patent Application Publication
(10) Pub. No.: US 2014/0091080 A1
(43) Pub. Date: Apr. 3, 2014

(54) METHOD FOR PRODUCING A RESISTANCE HEATING ELEMENT, AND RESISTANCE HEATING ELEMENT

(71) Applicants: Gotthard Nauditt, Huttenberg (DE); Roland Weiss, Huttenberg (DE); Jeremias Schonfeld, Huettenberg (DE)

(72) Inventors: Gotthard Nauditt, Huttenberg (DE); Roland Weiss, Huttenberg (DE); Jeremias Schonfeld, Huettenberg (DE)

(21) Appl. No.: 14/009,499

(22) PCT Filed: Apr. 4, 2012
(86) PCT No.: PCT/EP2012/056133

§ 371 Date: Dec. 17, 2013

(30) Foreign Application Priority Data
Apr. 6, 2011 (DE) 10 2011 006 847.3

(51) Int. Cl. H01C 17/30

(52) U.S. Cl. CPC H01C 17/30
USPC 219/553; 264/610

(57) ABSTRACT

The invention relates to a method for producing a resistance heating element and also to a resistance heating element (10), wherein the resistance heating element has a tubular shape, wherein the resistance heating element is formed in one piece, wherein the resistance heating element is produced from silicon carbide, the method comprising at least the following method steps:
forming a one-piece molded body from a powder of a sintering material, wherein the powder is pressed,
annealing the pressed molded body,
pyrolyzing the material of the molded body,
and sintering the molded body, wherein the molded body is formed into the resistance heating element.

The invention relates to a method for producing a resistance heating element having the features of Claim 1 and also to a resistance heating element having the features of Claim 16.

Resistance heating elements are routinely used as heating elements for a thermal analysis in so-called DSC furnaces (Dynamic differential calorimetry furnaces). Therefore, the known resistance heating elements are formed in the shape of a tube and in one piece and are contacted, on their bottom side, with an anode and a cathode and connecting surfaces, respectively. A wall of the resistance heating element is provided with two grooves, which are formed in the shape of a helix, thus forming heating coils of the resistance heating element. In the area of the heating coils of the resistance heating element, a temperature of up to 1650° C. is reached. Here, a glow pattern is supposed to be distributed across the area of the heating coils as homogeneously as possible. Furthermore, a high degree of purity of the manufacturing material of the resistance heating element is of great significance since, for instance when determining the purity of samples in a DSC furnace, undesirable additives could diffuse out of the resistance heating element and could distort a measurement.

Known resistance heating elements are essentially produced from silicon carbide. Producing of a resistance heating element is effected by forming a material blank from a fiber material, such as carbon fibers, by stabilizing the shape thereof by means of resin with concluding pyrolyzing as well as by infiltrating silicon, in order to obtain a resistance heating element that is made of silicon carbide. In particular due to an inhomogeneous distribution of the silicon within the molded body, it is also possible that cracks emerge. This also causes a reduced stability in the operating state of the resistance heating element since an irregular temperature distribution occurs within the resistance heating element due to the inhomogeneous concentrations of the manufacturing material. It is furthermore known to form a cylindrical molded body for forming an SiSiC resistance heating element by means of a slurry process. Here, in order to form a desired heating coil structure, a green body that is formed during a slurry process has to be processed. Here, a low rigidity of the green body substantially limits the processing possibilities, such that heating coils that are comparatively delicate cannot be produced by means of the slurry process. Another disadvantage of the known method is presented by the free silicon of the resistance heating element that is produced with this method since due to the free silicon, which can diffuse out of the resistance heating element, the maximum operating temperature is restricted to approximately 1400° C.

The present invention is therefore based on the task to propose a method for producing a resistance heating element and a resistance heating element, respectively, which avoids the disadvantages known from the state of the art.

This task is solved by a method having the features of claim 1 and by a resistance heating element having the features of claim 16.

With the method according to the invention for producing a resistance heating element, the resistance heating element has a tubular shape, wherein the resistance heating element is formed in one piece and wherein the resistance heating element is produced from silicon carbide, wherein the method comprises the following steps:
forming a one-piece molded body from a powder of a sintering material, wherein the powder is pressed,
annealing the pressed molded body,
pyrolyzing the materials of the molded body,
and sintering the molded body, wherein the molded body is formed into the resistance heating element.

In particular due to the fact that the one-piece molded body is pressed from a sintering material that is produced from a powder, it becomes possible to form molded bodies of virtually every shape, which have an essentially uniform distribution of the sintering material within the molded body. In this way, it is possible to avoid that undesirable concentrations of the manufacturing material within the molded body arise, which bring forward a forming of cracks during the production of the resistance heating element or during operation. Thus, it also becomes possible to produce the molded body in a comparatively cost-effective way since forming the molded body from sintering material can be carried out in a relatively simple way. Furthermore, if less cracks form, potential rejects during production are reduced, which also contributes to a lowering of costs. The resistance heating element that is produced in this way furthermore essentially does not include any free silicon, resulting in it being particularly well suited for a use at more than 1400° C.

The molded body that is made of sintering material can be produced by isostatically pressing the powder. With isostatic pressing, the powder is arranged in a mold shell, for instance in a tubular shape, and is subjected to a pressure within a liquid medium. Induced by the liquid medium, the pressure is distributed uniformly across the surface of the mold shell, resulting in a uniform distribution of the powder. A pressure during isostatic pressing can amount to 2000 bar or more. The molded body can to also be produced by semiisostatically pressing the powder, which means that, in that case, parts of the molded body and of the mold shell, respectively, are covered and are not put under pressure. For instance, the mold shell and the powder to be pressed, respectively, can be arranged around a thorn, wherein ends of the thorn respectively have an annular crosspiece. Between the annular crosspieces, the powder can then easily be arranged at the thorn and can be covered by a flexible mold shell. It is also conceivable to form the molded body such that it is already in its final shape.

The molded body that is made of sintering material can also be produced by die pressing the powder. Here, by die pressing the sintering material axially, not only tubular molded bodies, but also plate-shaped molded bodies can be formed.

Annealing of the pressed molded body that is made of sintering material can be effected in a protective atmosphere. Annealing at, for instance, 50 to 600° C. results in a curing of the molded body. The protective atmosphere can be formed by a protective gas or by a vacuum.

In a particularly simple embodiment, the molded body that is made of sintering material can be formed in the shape of a plate. With the same, a flat and straight resistance heating element can then be produced.

The molded body that is made of sintering material can have a round tubular cross-section. Thus, the molded body can have the desired form of the resistance heating element. It is also conceivable that a mechanical processing of the molded body can then be spared in the further production process. Preferably, a circular tubular cross-section can be formed since, in that case, a seamless molded body can simply be formed on a thorn. In principle, the molded body can, however, have any desired tubular shape.

In order to obtain a uniform distribution of silicon carbide and silicon to within the resistance heating element, it is advantageous if the molded body that is made of sintering material has a homogeneous distribution of powder. That means that within the manufacturing material of the molded body, no substantial density differences exist in that case. Thus, an undesirable accumulation of a manufacturing material, such as silicon, between particle structures that consist of silicon carbide can be avoided. Forming of cracks as a result of inhomogeneities can thus be avoided.

Furthermore, a homogeneous powder mixture can be formed. In that case, there are no essential differences in a distribution within the manufacturing material of the molded body or no areas with accumulations of specific manufacturing materials. A thorough intermixing of the powder can, for instance, be achieved with an Eirich mixer. A homogeneous powder mixture produces the same rigidity properties at each point of the manufacturing material of the molded body and thus avoids that cracks are formed.

In order to avoid material inclusions or bubbles to be produced within the molded body, the powder can be sieved before pressing. Sieving the powder can, amongst other things, also produce an improved mixture of the powder.

Advantageously, a binding agent can be used. A binding agent or a so-called precursor can be a polymer which is cross-linked by being exposed to temperature, hence being able to fix the powder in the shape of the molded body. Preferably, a silicon carbide precursor can be used, of which only silicon carbide remains in the manufacturing material of the resistance heating element after carrying out the production process.

The sintering material can be formed from the manufacturing materials phenolic resin, furan resin, formaldehyde resin, epoxides, silicon carbide, silicon, graphite, carbon black, polysilazanes, polycarbosilanes, polysiloxanes, polycarbosilazanes, or molybdenum disilicide or from combinations of such powders. The phenolic resin can also be present in powder form or in liquid form. Furthermore, as a lubricating agent and for avoiding oxidizing of the powder or of the sintering material, stearic acid can be added. In a preferred manner, a powder mixture of silicon carbide, silicon, carbon and polycarbosilane can be used.

After annealing, a mechanical processing of the molded body can be effected, wherein a final shape of the resistance heating element can be formed by means of the mechanical processing. Thus, an inner diameter of the molded body can be bored up further or can be milled out and a cylinder or an outer diameter can be ground on a lathe, for instance, such that a uniform wall thickness of the molded body of, for instance, up to 1 mm is formed. In particular due to a high mechanical stability of the molded body, the method can thus also make it possible to produce delicate heating coils. Furthermore, helical grooves can be milled into the molded body that was processed in this way, such, that a future heating coil of the resistance heating element is formed. In a base area or between connecting surfaces of the molded body and of the resistance heating element, respectively, the grooves can be formed as bypassing crosspieces that ensure the stability of the molded body during the production process. After the resistance heating element has been formed, said crosspieces can simply be cut through and thus be removed.

Advantageously, after sintering, a high-temperature treatment of the resistance heating element can be effected. Sintering can be carried out in a temperature range from 1350 to 1900° C. and the high-temperature treatment in a temperature range from 1900 to 2400° C. Amongst other things, the high-temperature treatment can serve to free oxygen and nitrogen in the molded body and can be carried out under vacuum or protective gas. By means of the high-temperature treatment in particular, dimensional deviations of the molded body that are induced by the method steps can be minimized.

In order to prevent free silicon from escaping during operation of the resistance heating element, a CVD coating process (chemical vapour deposition) of the resistance heating element with silicon carbide can additionally be effected after sintering. With the CVD coating process, a silicon carbide layer is applied onto the resistance heating element, for instance at 700 to 1500° C. The silicon carbide layer encloses the resistance heating element essentially completely, such that silicon that might be trapped within the manufacturing material of the resistance heating element cannot escape from the same.

A particularly good contacting of the resistance heating element with connecting contacts can be achieved if, after sintering or after the CVD coating process, connecting surfaces of the resistance heating element are coated by flame spraying. By means of thermal spraying of aluminum in powder form, the connecting surfaces can thus be provided with an aluminum layer that can easily be contacted electrically. Aluminum can easily be processed by means of flame spraying and does not melt off from the resistance heating element during operation of the same.

The resistance heating element according to the invention has an essentially arbitrary shape, wherein the resistance heating element is formed in one piece, wherein the resistance heating element is produced from silicon carbide, and wherein the resistance heating element has a homogeneous structure or a homogeneous distribution of silicon carbide. In particular the homogeneous structure of silicon carbide within the manufacturing material composition of the resistance heating element has the effect of minimizing the probability that cracks are formed during operation of the resistance heating element. Thus, operational to safety of the resistance heating element can be substantially advanced. Preferably, the resistance heating element has a tubular shape.

Advantageously, the silicon carbide in the material of the resistance heating element can be structured corresponding to a particle orientation of a powder.

Further advantageous embodiments of a resistance heating element result from the descriptions of the features contained in the independent claims which relate back to the process claim 1.

In the following, the invention is explained in more detail with reference to the enclosed drawing.

In the drawings:

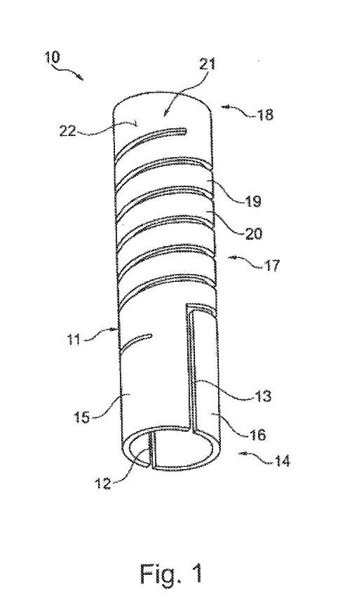

FIG. 1: shows a perspective view of a resistance heating element;

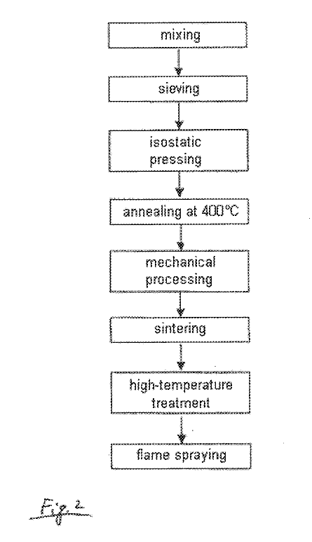

FIG. 2: shows a flow chart for an embodiment of the method.

FIG. 1 shows a resistance heating element 10, which is formed in the shape of a tube and with a round circular cross-section. The resistance heating element 10 includes a thin tube wall 11, which is penetrated by two grooves 12 and 13. The grooves 12 and 13, having a straight shape, are formed in the area of a lower end 14 of the resistance heating element 10 in the longitudinal direction of the same, thus forming two connecting surfaces 15 and 16 for connecting the resistance heating element 10 to connecting contacts of a connecting device, which is not shown here and which belongs to a DSC furnace. In a middle area 17 of the resistance heating element 10, the grooves 12 and 13, in the shape of a helix, respectively extend in the longitudinal direction along the circumference of the tube wall 11 to an upper end 18 of the resistance heating element 10. The grooves 12 and 13 thus form two heating coils 19 and 20, which are connected to each other at the upper end 18 in an annular section 21. Heating the resistance heating element 10 during operation is essentially effected in the area of the heating coils 19 and 20. The resistance heating element is formed in one piece and essentially consists of silicon carbide, wherein, within the manufacturing material of the resistance heating element 10, residual amounts of silicon, carbon and other manufacturing materials resulting from the production process can be bound. Furthermore, a surface 22 of the resistance heating element 10 is almost completely coated with silicon carbide, wherein, in the area of the connecting surfaces 15 and 16, a layer of aluminum, which is not shown in detail here, is applied.

FIG. 2 shows a possible flow chart of an embodiment of the process. Initially, mixing and sieving of several sintering materials in powder form, such as silicon carbide, silicon, carbon, polymers such as polysilazanes, polycarbosilazane, polycarbosilanes, polysiloxanes, or other prepolymers such as phenolic resin, polyimides, polyfurans etc., is effected. This powder mixture is arranged around a round thorn, such that a tubular molded body emerges. The powder mixture is covered by a mold shell and is pressed semiisostatically, such that a compression of the powder mixture takes place. The molded body that is produced in this way is annealed at approximately 400° C., hence being cured, such that a mechanical processing of the molded body by means of grounding on a lathe can be effected. In the process, an inner and an outer diameter of the tubular and round molded body is processed in such a way that the molded body has a substantially uniform wall thickness of 3 mm. Furthermore, grooves for forming heating coils and connecting surfaces are milled into the tube wall of the molded body. Finally, pyrolizing of the material of the molded body at 850 to 1200° C., during which the material is partly converted into carbon, as well as sintering of the molded body at 1650 to 1900° C., during which the molded body is formed into the resistance heating element, are effected. Now, the resistance heating element substantially consists of silicon carbide. After sintering, an optional high-temperature treatment follows as well as a coating of the connecting surfaces with aluminum by means of flame spraying.

1. A method for producing a silicon carbide resistance heating element, the method comprising at least the following method steps:
forming a one-piece pressed molded body from a powder of a sintering material;
annealing the pressed molded body;
pyrolyzing the material of the molded body; and
sintering the molded body.

2. The method according to claim 1, in which the molded body is produced by isostatically pressing the powder.

3. The method according to claim 1, in which the molded body is produced by die pressing the powder.

4. The method according to claim 1, in which annealing of the molded body is effected in a protective atmosphere.

5. The method according to claim 1, in which the molded body is formed in the shape of a plate.

6. The method according to claim 1, in which the molded body has a round tubular cross-section.

7. The method according to claim 1, in which the molded body has a homogeneous distribution of powder.

8. The method according to claim 1, in which the sintering material is a homogeneous powder mixture.

9. The method according to claim 1, in which the powder is sieved.

10. The method according to claim 1, in which a binding agent is used to bind the powder.

11. The method according to claim 1, in which the sintering material is selected from a group consisting of phenolic resin, furan resin, formaldehyde resin, epoxides, silicon carbide, silicon, graphite, carbon black, polysilazanes, polycarbosilanes, polysiloxanes, polycarbosilazanes, and molybdenum disilicide, or from combinations of such powders.

12. The method according to claim 1, in which after annealing, a mechanical processing of the molded body is effected, wherein a final shape of the resistance heating element is formed.

13. The method according to claim 1, in which after sintering, a high-temperature treatment of the molded body is effected.

14. The method according to claim 1, in which after sintering, a CVD coating process of the molded body is effected.

15. The method according to claim 1, in which after sintering, connecting surfaces of the molded body are coated by flame spraying.

16. A resistance heating element comprising:
a one piece pressed molded body having a homogeneous distribution of silicon carbide.
